(19) United States
(12) Patent Application Publication
(10) Pub. No.: US 2006/0173853 A1
(43) Pub. Date: Aug. 3, 2006

(54) Method and system for locating information on local networks

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/048,245

(22) Filed: Jan. 31, 2005

(51) Int. Cl. G06F 17/30

(52) U.S. Cl. 707/10

(57) ABSTRACT

A method and system for providing access to a service through any of a plurality of local networks is described. The method and system include receiving a request for the information from a computing device through at least one of the plurality of networks. The request includes a standard identifier identifying the service for each of the local networks and associated with a location of the service for each of the local networks. The method and system further include locating the service for the at least one of the plurality of local networks based on the standard identifier and allowing the computing device to access the service through the at least one of the plurality of local networks.

### FIELD OF THE INVENTION

The present invention relates to computer networks, and more particularly to a method and system for locating information on a local network.

### BACKGROUND OF THE INVENTION

Computing devices, such as cellular telephones that are 802.11 enabled, digital cameras, personal computers, camera-phones, and the like, are often connected to local networks in order to upload information from or download information to the local network. Various conventional mechanisms exist for allowing computing devices to locate information on local computer networks, each of which has significant drawbacks. For example, many conventional applications exist for mobile computing devices such as camera-phones to connect to and access information on local networks. Examples of such conventional applications can be found in U.S. Pat. No. 6,798,358 and in published U.S. Patent Application 2002/0022491. Such conventional applications utilize the geographic location, or position, of the mobile computing devices. However, providing the position of the mobile computing device may be undesirable for privacy reasons.

Similarly, location-based directory services exist. Such services include directories having information in which users of mobile computing devices may be interested. For example, a directory service for a local area network of a shopping center may be accessible through a wireless device physically located in the shopping center. Such a directory service might provide locations of stores in the shopping center, inventories of the stores or other information. However, such conventional services typically utilize the position of the mobile computing devices. As stated above, providing the position of the mobile computing device may be undesirable due to privacy concerns. Further, it may be costly for vendors to have information related to their products or businesses accessible through such conventional services.

Other conventional directory services, such as LDAP and JINI, can also be used to provide information in local networks to computing devices coupled to the local networks. However, one of ordinary skill in the art will recognize that such conventional services typically require additional information that is specific to the local network. In particular, a request for information from the directory service typically includes the address of the directory in the local network or analogous data used to locate the directory. In the example of the local network for the shopping center, the request may include the name and/or address of the directory in the shopping center's local network. Such information specific to the local network would not necessarily function for another local network. Because of the use of information specific to certain local networks, it becomes more difficult for the user to utilize such services when changing locations and/or using a different local network. In addition, for services such as JINI, a compatible client must exist on the computing device. Further, services such as JINI download code to the computing device. One of ordinary skill in the art will readily realize that ensuring that the computing device has a particular type of client is burdensome to the user. Downloading code to the computing device may also expose the computing device to attack. Consequently, such conventional directory services have significant drawbacks.

Universal Plug and Play (UPnP) allows a computing device to detect new devices attached to the computing device and use these devices. Similarly, UDDI is configured to allow the device to utilize software enhancements. Further, applications such as UDDI are at a programmatic level and thus may not have a user interface. Moreover, UPN and UDDI require support for specific protocols that may not be supported on a number of devices. Consequently, one of ordinary skill in the art will readily recognize that there are drawbacks for using application such as UPnP and UDDI to access information, particularly information for which such applications were not originally intended to allow a user to access information in local networks.

Accordingly, what is needed is an improved method and system for locating information on local networks. The present invention addresses such a need.

### BRIEF SUMMARY OF THE INVENTION

The present invention provides a method and system for providing access to a service through any of a plurality of local networks. The method and system comprise receiving a request for the information from a computing device through at least one of the plurality of networks. The request includes a standard identifier identifying the service for each of the local networks and associated with a location of the service for each of the local networks. The method and system further comprise locating the service for the at least one of the plurality of local networks based on the standard identifier and allowing the computing device to access the service through the at least one of the plurality of local networks.

According to the method and system disclosed herein, the present invention allows services to be accessed through the local area network without providing the geographic position of the computing device. Instead, standard identifiers such as standard host names and standard path extensions may be provided to allow users to find specific types of web pages specific to the local network to which their device is connected.

### BRIEF DESCRIPTION OF SEVERAL VIEWS OF THE DRAWINGS

FIG. 1 is a diagram of one embodiment of a network in accordance with the present invention.

FIG. 2 is a diagram depicting one embodiment of an exemplary DNS zone file mapping.

FIG. 3 is a block diagram depicting one embodiment of a computing device in accordance with the present invention that can be used in locating information on a local network.

FIG. 4 is a block diagram depicting a first embodiment of a user interface for computing device in accordance with the present invention that can be used in locating information on a local network.

FIG. 5 is a block diagram depicting a second embodiment of a user interface for computing device in accordance with the present invention that can be used in locating information on a local network.

FIG. 6 is a block diagram depicting a third embodiment of a user interface for computing device in accordance with the present invention that can be used in locating information on a local network.

FIG. 7 is a block diagram depicting a fourth embodiment of a user interface for computing device in accordance with the present invention that can be used in locating information on a local network.

FIG. 8 is a flow chart depicting one embodiment of a method in accordance with the present invention for locating information on a local network.

FIG. 9 is a more detailed flow chart depicting another embodiment of a method in accordance with the present invention for locating information on a local network.

FIG. 10 is a flow chart depicting one embodiment of a method in accordance with the present invention for providing a computing device used in locating information on a local network.

### DETAILED DESCRIPTION OF THE INVENTION

The present invention relates to obtaining information on local networks. The following description is presented to enable one of ordinary skill in the art to make and use the invention and is provided in the context of a patent application and its requirements. Various modifications to the preferred embodiments and the principles and features described herein will be readily apparent to those skilled in the art. Thus, the present invention is not intended to be limited to the embodiments shown, but is to be accorded the widest scope consistent with the principles and features described herein.

The present invention provides a method and system for providing access to a service through any of a plurality of local networks. The method and system comprise receiving a request for the information from a computing device through at least one of the plurality of networks. The request includes a standard identifier identifying the service for each of the local networks and associated with a location of the service for each of the local networks. The method and system further comprise locating the service for the at least one of the plurality of local networks based on the standard identifier and allowing the computing device to access the service through the at least one of the plurality of local networks.

The present invention will be described in terms of a particular local area network. However, one of ordinary skill in the art will readily recognize that nothing prevents the use of another network having other and/or different components not inconsistent with the present invention. The present invention is also described in terms of a particular method having certain steps. However, one of ordinary skill in the art will readily recognize that nothing prevents the use of other methods having other and/or different steps not inconsistent with the present invention.

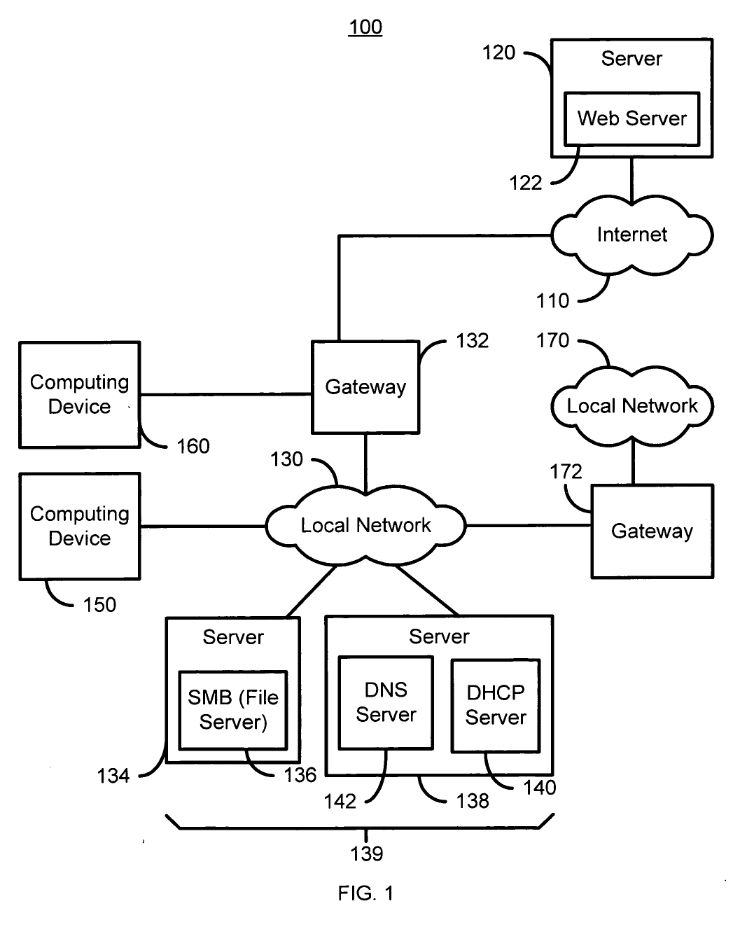

FIG. 1 is a diagram of one embodiment of a network 100 in which the method and system in accordance with the present invention can be used. The network 100 includes the internet 110, server 120 including a web server 122, a first local network 130, computing devices 150 and 160, and a second local network 170. The first local network 130 includes a gateway 132, servers 134 and 138, as well as other components 139. The server 134 includes SMB file server 136. The server 138 is depicted as including dynamic host configuration protocol (DHCP) server 140 and domain name service (DNS) server 142. Although the local network 130 is depicted as including DHCP server 140 and DNS server 142, in an alternate embodiment, another type of server, such as a session internet protocol (SIP) server could be used. Moreover, the local network 130 may include other and/or additional components that are not shown.

For clarity, the method and system in accordance with the present invention are described in the context of the local network 130. The local area network 130 has been configured to receive from the computing devices 150 and 160 requests for service(s) through the local network 130. In a preferred embodiment, the request from the computing devices exclude position information for the computing devices 150 and 160. In addition the requests preferably exclude an indication of the location of the information that is specific to the local network 130. For example, such requests would preferably not include the actual address or name of the information or site of interest in the local network 130. However, the requests do include a standard identifier which identifies the service for each of the local networks 130 and 170. The standard identifier is also associated with a location of the service for each of the local networks 130 and 170. The standard identifier is understood by any local network complying with the standard to refer to a service and its location associated the local network. Thus, if such a request were provided to the local network 130 or 170, the standard identifier would refer to the service for the local network 130 or 170, respectively. The request may thus be routed to an address for the local network 130 or 170. Consequently, the request can be translated by the local network 130 and the service for the local network 130 may be accessed by the requesting client 150 or 160. Note that the term service, as used herein, is broadly defined. For example, the services provided can include but are not limited to the home page of the local network 130; services such as directory services, local printers and file servers; services such as http services for obtaining and viewing images; or other services.

In a preferred embodiment, the standard identifier of the services includes standard local name(s) that correspond to address(es) at which information is stored. As used herein, a standard local name is one that corresponds to an actual location for the local network 130. Thus, for a request provided to any local network 130 or 170, the standard local name is for a service for that network 130 or 170. The standard local name can be mapped by each local network 130 and 170 to an address that is specific to that local network 130 and 170, respectively. There is no requirement that the address actually be on the local network 130 or 170, merely that the service be accessed through the local network. Such standard local names are similar to the name localhost.localdomain, which always refers to the requesting device in DNS. In a preferred embodiment, the standard local names are DNS names. For example, one standard name, such as httplocal, may be used to route the request to a web server which is specific to the local network 130 to which the computing device is connected. This may be accomplished by adding an entry in the DNS server 142 for the local network 130 which associates the reserved well-known name with the specific address associated with the service requested. This naming scheme can be extended to other services that correspond to requests for specific information, as described below. Alternatively, the DNS names photoAlbum.httplocal, addressBook.httplocal, and faq.httplocal would be configured to IP addresses whose web servers that would support the local's photoalbums, addressBook, and FAQ respectively. The first example which uses a well-known name for the host and well known path extensions for the services is a preferred embodiment because it requires only one IP address and requires less network configuration. Multiple servers (not shown) could provide also web support through URL redirection.

Such standard local names might include, but are not limited to the following. For information services, the names httplocal and ftplocal may be used for the local web server and ftp server. Similarly, the standard local name smblocal can be used to access information through the local area network's default SMB file server 136. In FIG. 1, such standard local names may also be used for other services. For example, standard names might include standard path extensions for various services. Standard path extensions for photo-sharing services might include/ -home page, root folder, /image, /video, /audio, /addressBook, /member-membership, /faq, /support, /contact, /about, /cart, and /catalog. For example to access the photo-sharing service faq on a local network the device's web browser would request http://httplocal/photo-sharing/faq. Similarly, standard path extensions might be used for various retailers' home pages. For example, standard path extensions for the home and root folders could be used such as /member-membership, /faq, /support, /contact, /about, /cart, /catalog, and /search. For example, a user could enter any retailer's store which supports the naming standard with a WiFi enabled PDA or phone and access the retailer's current inventory through the device's browser using the standard URL http://httplocal/store/catalog. Analogous path extensions might be used for a corporate site. Standard local names may be provided for network services such as jinilocal—JINI directory server, uddilocal—UDDI server, ldaplocal—LDAP server, dnslocal—DNS server, dhcplocal—DHCP server, gatewaylocal—gateway server, smtplocal—SMTP server, and poplocal—pop server. Thus to use the outgoing mail server when visiting a corporate business location, a visitor could connect to the local LAN and have his mail client send mail to the well-known name smtplocal. Note that although the above names are provided as examples of standard local names other standard local names might be chosen. In addition, the standard local names need not bear any resemblance to the actual function or address or real names of the locations which the standard local names represent. Further, although standard local names are preferred, nothing prevents the use of another mechanism for utilizing standard identifiers for identifying services and associating services with their locations specific to local networks using the standard identifiers,

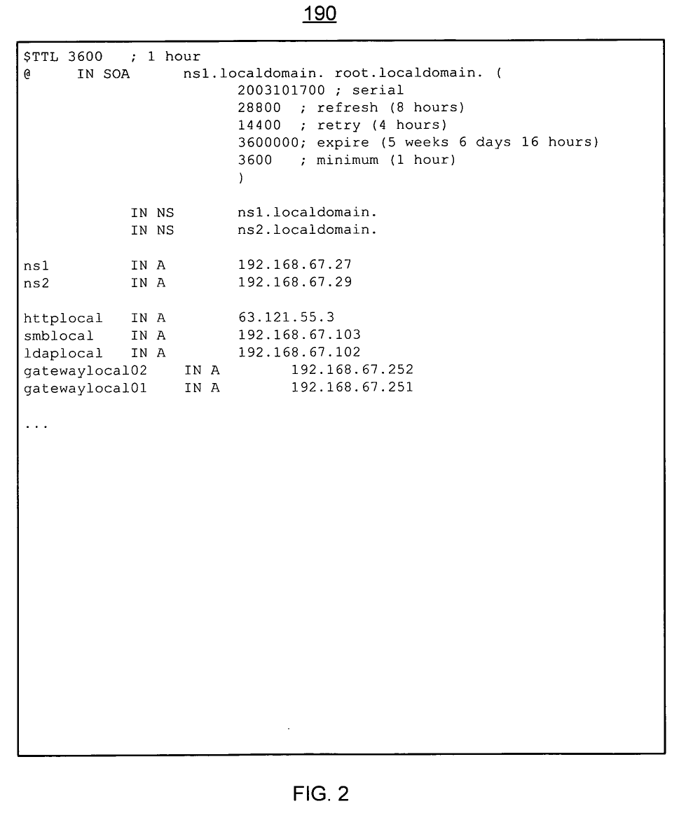

In a preferred embodiment, the computing device contacts a DHCP server 140 to get it's own address and the address of the DNS server(s) to use while connected to the local network. The DNS server contains entries for each of the well-known names which correspond to servers providing a service which corresponds to each well-known name. For example, FIG. 2 depicts is a diagram depicting one embodiment of an exemplary DNS zone file mapping standard names httplocal, smblocal, ldaplocal, gatewayloca101, and gatewayloca102 to specific addresses. There are a number of DNS embodiments using DNS that can be built. Some embodiments may require changes to the BIND code while others may not. The most straight-forward implementation is to use a normal DNS zone file and add alias entries for each of the standard identifiers for the services supported on the network. FIG. 2 shows illustrates an embodiment with a special zone file for the “localdomain”. Guests on the local network would use identifiers only known to in the localdomain zone, thus hiding other addresses on the local network. Referring back to FIG. 1, in the current art the DNS system has no system for standardizing names across domains. Even if such a standard did exist, a domain or subdomain can span more than one local network. The current embodiment allows for duplicate names (i.e. standard identifiers) within a domain via the localdomain zone. A DNS server providing services for a particular local network is enabled to recognize that the standard identifiers existing on multiple DNS servers serving the same domain are not duplicate names, but have specific address mappings for the local network it serves. Each DNS server can be configured to not pass name resolution for standard identifiers up to its parent if it's not resolved locally. In some cases it makes sense to allow the name resolution for standard identifiers to be passed up if a common server is providing a service for more than one local network.

In an alternate embodiment, another entity, such as the gateway 132 shown in FIG. 1 or a wireless access point (not shown), may intercept the requests using the standard local names and perform the address mapping. The DNS server 142 preferably translates the standard local names to addresses within the local network 130. Note that extensions to well known server names are not handled by the DNS embodiment. In the preferred embodiment, extensions are translated by the service to which the well-known server name refers. For example, given the well-known name with extension “httplocal/about”, the DNS server maps httplocal to the address of the default web server for the local network, and the web server hosting the service maps the well-known “about” extension to the page providing introductory information about the location. In another alternate embodiment, other component(s), such a SIP server (not shown in FIG. 1) may be used to translate the standard local names and extensions to an address and specific information or service indicated by the well-known name and extension. In a SIP embodiment, the services would preferably register their locations with the SIP registry.

In an alternate embodiment, the translation of the standard local name to an address need not result in a mapping to an address on the local network 130. For example, the translation of the standard local name for a request to the local network 130 for the default web server might result in a mapping to an address to a server 120 hosting a web server 122 on another network 110. In this case the web server 122 might service several local networks as one network or it may identify the origin of each request by the source IP address and return results specific to the local network.

Once the request is translated to an address, the local network 130 functions in an analogous manner to a conventional local network. Thus, the computing device is allowed to access the service requested. In a preferred embodiment, this is accomplished at least in part by locating the address of the service and returning the address to the computing device 150 or 160 from which the request was made.

The network 100 can thus process requests which include a standard identifier of the service. For example, the user may connect to the home page of a new local network, may view photos, and may view catalog or inventory information. Furthermore, the standard identifier for identifying the services and being associated with the location of the services can be extended to other information and/or services not described above. A user's ability to easily access a variety of information from different local networks is thereby enhanced.

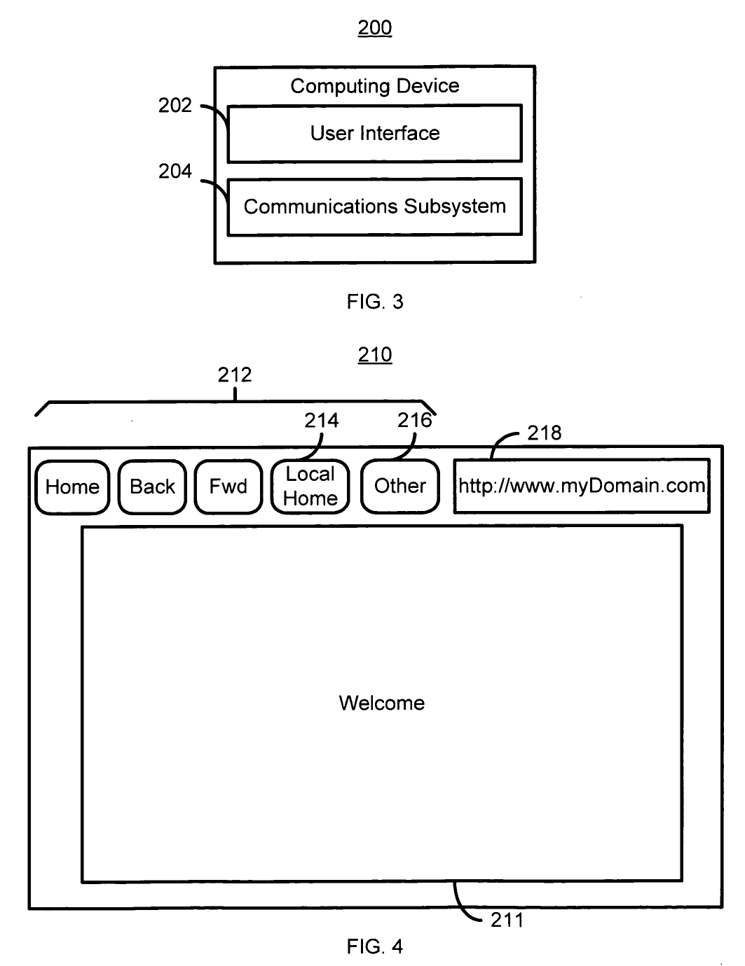

FIG. 3 is a block diagram depicting one embodiment of a computing device 200 in accordance with the present invention that can be used in locating information on a local network. The computing device 200 might be used for the computing device 150 or 160 depicted in FIG. 1. Referring back to FIG. 3, the computing device 200 includes a user interface (UI) 202 and a communication subsystem 204. The communication subsystem 204 sends data to and receives data from external entities. Thus, the request would be sent and any response received via the communication subsystem 204.

The UI 202 generates the request that includes the standard identifier for the service. Because a standard identifier is used, the service may be requested using a single command, a single menu item, or a single button.

FIG. 4 is a block diagram depicting a first embodiment of a UI 210 for computing device in accordance with the present invention that can be used in locating information on a local network. The user interface 210 may be used for the UI 202 depicted in FIG. 3. Referring back to FIG. 4, the UI 210 is preferably for a browser. The UI 210 includes a display portion 211, an indication of the current address 218, and buttons 212. Although five buttons 212 are depicted, nothing prevents the use of another number of buttons 212. The buttons 214 and 216 are used to generate the requests in accordance with the present invention. In the UI 210 shown, the button 214 is a local home button. Consequently, the button 214 generates a request for the local homepage that uses a standard identifier for the local homepage, and preferably excludes both the position information for the computing device corresponding to the UI 210 and the local network specific indication, or address, of the local homepage. Similarly, the button 216 may be used for another analogous, preferably predetermined, request. For example, the button 216 might be used to generate a request to access to a particular local service or to view photos available on the local network. Thus, in combination with the system 100, a user may obtain services through any number of local networks merely by selecting a button on the menu of the UI 210.

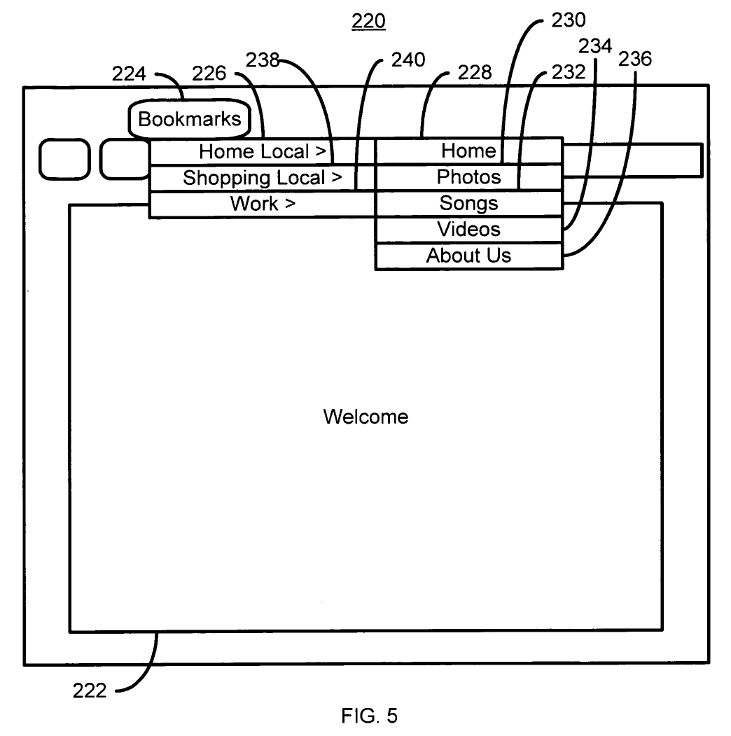

FIG. 5 is a block diagram depicting a second embodiment of a UI 220 for computing device in accordance with the present invention that can be used in locating information on a local network. The user interface 220 may be used for the UI 202 depicted in FIG. 3. Referring back to FIG. 5, the UI 220 is preferably for a browser. The UI 220 includes a display portion 221, and bookmarks 224. The bookmarks 225 include local home 226, shopping local 238, and work 240 bookmarks. Each of the bookmarks 226, 238, and 240 corresponds to a number of other menu items, each of which can generate a request in accordance with the present invention. As shown in FIG. 5, the home local bookmark 226 corresponds to menu items home 228, photos 230, songs 232, videos 234, and about us 236. Upon being selected by a user, each of the menu items 228, 230, 232, 234, and 236 generates a request in accordance with the present invention. For example, the home 228 menu item generates a request that includes a standard identifier for the service for the local network and results in the local network returning the local home page for the local network to which the computing device is connected. Thus, in combination with the system 100, a user may obtain information from various local networks merely by selecting a menu item of the bookmarks 224 of the UI 220. The bookmarks work consistently across all local networks which support the standard names or indications

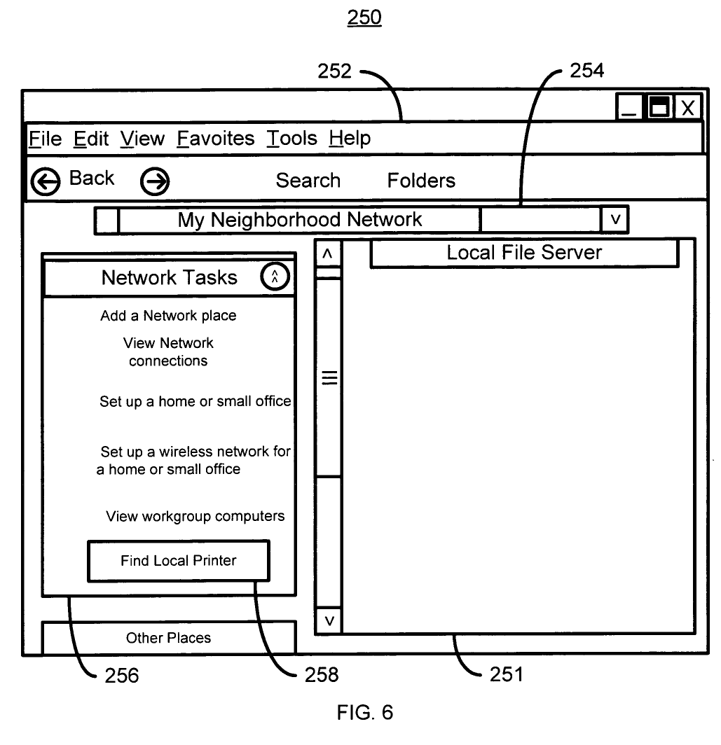

FIG. 6 is a block diagram depicting a third embodiment of a UI 250 for computing device in accordance with the present invention that can be used in locating information on a local network. The user interface 250 may be used for the UI 202 depicted in FIG. 3. Referring back to FIG. 6, the UI 250 is a window in GUI displaying for example resources accessible via a SMB group or domain. The UI 250 includes a pane 251 indicating certain available resources, a toolbar 252, as well as an indication of the current address 254 in the local network. The UI 250 also includes network tasks pane 256. The network tasks pane 256 may include one or more items that can be used to generate a request in accordance with the present invention. For example, in the embodiment shown, the find local printer task 258 is selected. The find local printer task 258 is an example of one of the tasks that might be implemented in accordance with the present invention. For example, a printer accessible via SMB protocols may have a well-known name of smb-printer-ps. In particular, selection of the find local printer task 258 results in a request that includes a standard identifier for the local printers' information's location in the local network, but excludes a network specific indication of the location of the local printers, excludes position information for the computing device corresponding to the UI 250 and returns available local printers, after processing by the local network 130 as described above and below. Thus, in combination with the system 100, a user may obtain information from local networks merely by selecting a menu item of the UI 250.

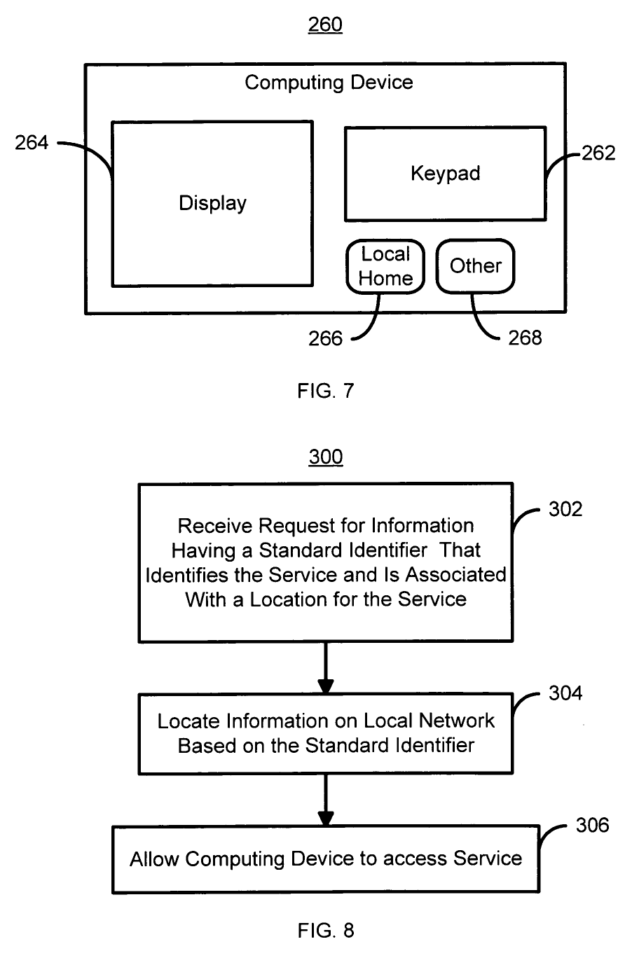

FIG. 7 is a block diagram depicting a fourth embodiment of a UI 260 for computing device in accordance with the present invention that can be used in accessing a service through a local network. The user interface 260 may be used for the UI 202 depicted in FIG. 3. Referring back to FIG. 7, the UI 260 is preferably for a camera phone. However, an analogous UI 260 might be provided for another computing device, including but not limited to a digital camera. The UI 260 includes a keypad 262, a display 264, and hardware buttons 266 and 268. The keypad 262 is preferably used for dialing numbers, as well as accessing certain other functions of the computing device. The display 264 may be used for displaying phone numbers, pictures, or other information. The hardware buttons 266 and 268 are used to generate requests in accordance with the present invention in response to the hardware buttons 266 and 268 being pushed. The hardware button 266 is depicted as being used for accessing a local home page, while the hardware button 266 is used to access another function. However, nothing prevents the use of hardware buttons 266 and 268 for other purposes, or the use of another number of hardware buttons. For example, pushing the local home page 266 menu item generates a request that includes a standard identifier for the local home page service of the local network, but preferably excludes a network specific indication of the location of the home page, preferably excludes position information for the computing device corresponding to the UI 260 and returns the local home page for the local network to which the computing device is connected. Thus, in combination with the system 100, a user may obtain information from local networks merely by selecting a hardware button on the UI 260.

Thus, the computing device 200 that may include one or more of the UIs 210, 220, 250, and 260. When used in conjunction with the network 100, it is possible to process a variety of requests which include a standard identifier for the service. A user's ability to easily access a variety of services from different local networks is thus enhanced.

FIG. 8 is a flow chart depicting one embodiment of a method 300 in accordance with the present invention for locating information on a local network. The method 300 is described in the context of the network 100 and computing device 200. However, nothing prevents the use of the method 300 with another network 100 and/or computing device 200 not inconsistent with the present invention. A request for the information is received from a computing device 200, via step 302. In a preferred embodiment, the request is received and resolved using the DNS server 142. However, the request may be received in another manner. As discussed above, the request includes a standard identifier for the service and preferably excludes both position information for the computing device 200 and any indication of the location of the information specific to the local network 130. The information is located through the local network based on the standard identifier, via step 304. In a preferred embodiment, step 304 includes translating the standard identifier to an address corresponding to a service such as LDAP or other service for the local network, such as the home page. The computing device 200 is allowed to access the service, via step 306.

Thus, using the method 300, requests which include a standard identifier for the service, but preferably exclude the position of the computing device or any network specific location of the information can be processed more easily. For example, the user may connect to the home page of a new local network, may view photos, and may view catalog or inventory information. Furthermore, the standard indications of the location of the information can be extended to other information and/or services not described above. A user's ability to easily access a variety of information from different local networks is thereby enhanced.

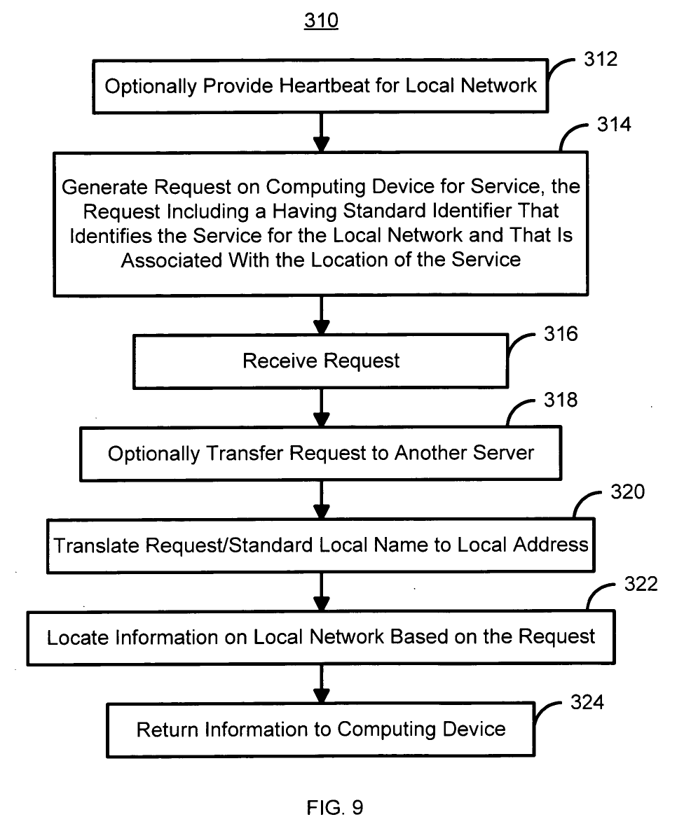

FIG. 9 is a more detailed flow chart depicting another embodiment of a method 310 in accordance with the present invention for locating information on a local network. The method 310 is described in the context of the network 100 and computing device 200. However, nothing prevents the use of the method 310 with another network 100 and/or computing device 200 not inconsistent with the present invention. A heartbeat is optionally provided from the local network 130, via step 312. The heartbeat is typically from a DHCP server which allows the device to obtain an address and minimal network configuration. A request is generated by the computing device 200, via step 314. As discussed above, the request includes a standard identifier for the service. Neither position information for the computing device 200 nor any indication of the location of the service specific to the local network 130 is required. Preferably, the request includes at least one standard local name corresponding to the service. The request for the service is received from the computing device 200, via step 316. In a preferred embodiment, the request is received and routed using the DNS server 142. However, the request may be received in another manner. The request is optionally transferred to another entity in the local network 130, via step 318. For example, the request may be transferred from the DHCP server 140 to the DNS server 142. The standard local name is translated to an address associated with the local network 130, via step 320. Step 320 may also include resolving any extensions that are part of the standard local name, but this typically occurs at the service or information source in step 324. Moreover, as discussed above, the network specific address may be an address on the local network 130 or elsewhere. The service is located for the local network at the location using the address, via step 322. The computing device 200 is allowed to access the service, via step 324. Preferably, step 324 includes returning the address of the service to the computing device 200.

Thus, using the method 310, requests which include a standard identifier, preferably the standard local name, for the service, but preferably exclude the position of the computing device or any network specific location of the information can be processed. A user's ability to easily access a variety of information from different local networks is thereby enhanced.

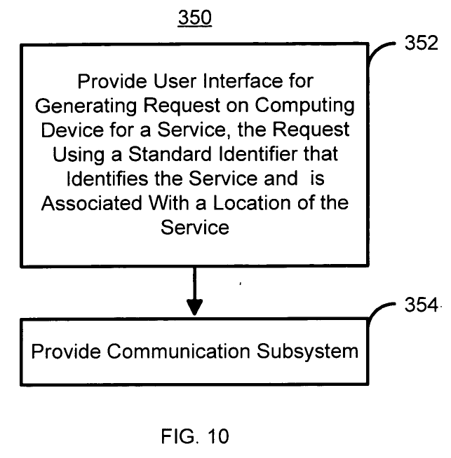

FIG. 10 is a flow chart depicting one embodiment of a method 350 in accordance with the present invention for providing a computing device used in locating information on a local network. The method 350 is described in the context of the computing device 200. However, nothing prevents the use of the method 350 with another computing device. A user interface 202 is provided, via step 352. The user interface 202 is capable of initiating a request for the information from the computing device 200. As described above, the request includes a standard identifier for the service that identifies the service for the local network through which the service is accessed. The standard identifier is also associated with location of the server for the local network. In a preferred embodiment, the standard identifier of the location takes the form of a standard local name, as described above. Also in a preferred embodiment, step 352 includes providing means for generating the request using a single command, such as a push of a button or selection of a menu item. Thus, in a preferred embodiment, step 352 includes providing the UI 210, 220, 250 or 260. A communication subsystem 204 is also provided as part of the computing device 200, via step 354. The communication system is for sending the request to the local network and for receiving the information from the local network in response to the request to the computing device.

Thus, using the method 350, a computing device 200 may be provided. Using such a computing device, a user can easily communicate with a local area network. Further, such a communication device facilitates generation of requests for service in accordance with the present invention.

A method and system for locating information on a local network has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A method for providing access to a service through any of a plurality of local networks comprising:
receiving a request for the service from a computing device through at least one of the plurality of local networks, the request including a standard identifier identifying the service for each of the plurality of local networks and associated with a location of the service for each of the plurality of local networks;
locating the service for the at least one of the plurality of local networks based on the standard identifier; and
allowing the computing device to access the service through the at least one of the plurality of local networks.

2. The method of claim 1 wherein the receiving further includes:
receiving the request for the service, the standard identifier including at least one standard local name corresponding to an address for accessing the service though the at least one local network.

3. The method of claim 2 wherein the locating further includes:
locating the service using the address; and

4. The method of claim 2 wherein the locating further includes:
translating the at least one standard local name to the address;.

5. The method of claim 4 wherein the translating further includes:
translating the request using a DNS server.

6. The method of claim 3 wherein the receiving further includes:
receiving the request at a first server; and wherein the translating further includes transferring the request to a second server; and
translating the standard local name to the address using the second server.

7. The method of claim 1 wherein the allowing further includes:
returning to the computing device an address for accessing the service though the at least one local network.

8. The method of claim 1 wherein the receiving further includes:
allowing the request to be generated on the computing device using a single command.

9. The method of claim 8 wherein the request allowing further includes allowing the request to be generated by a push of a button.

10. The method of claim 8 wherein the request allowing further includes allowing the request to be generated by selection of a menu item.

11. The method of claim 1 further comprising:
allowing a server on the local network to send out a heartbeat, the heartbeat indicating a presence of the local network; and
connecting to the local network based on the heartbeat.

12. A method for locating a service through any of a plurality of local networks comprising:
defining a standard name for use in a local network request for the service;
adding an entry in each of a plurality of servers that serve each of the plurality of local networks, each of the plurality of servers associating the standard name with a specific address for the service through a corresponding local network of the plurality of networks;
in response to a server of the plurality of servers receiving the local network request including the standard name, sending the request to the specific address through the corresponding local network for the server; and
providing the service to the computing device.

13. A method for providing access to a service through any of a plurality of local networks comprising:
generating a request for the information on a computing device, the request including a standard identifier identifying the service for each of the plurality of local networks and associated with a location of the service for each of the plurality of local networks; and
sending the request through the at least one of the plurality of local networks for accessing the service through the at least one local network.

14. The method of claim 13 wherein the standard identifier includes at least one standard local name, the at least one standard local name corresponding to an address for accessing the service through the local network.

15. The method of claim 13 wherein the request is generated on the computing device using a single command.

16. The method of claim 15 wherein the request is generated in response to a push of a button included on the computing device.

17. The method of claim 15 wherein the single command corresponds to a menu item.

18. A computer-readable medium containing a program for providing access to a service through any of a plurality of local networks, the program including instructions for:
receiving a request for the service from a computing device through at least one of the plurality of local networks, the request including a standard identifier identifying the service for each of the plurality of local networks and associated with a location of the service for each of the plurality of local networks;
locating the service for the at least one of the plurality of local networks based on the standard identifier; and
allowing the computing device to access the service through the at least one of the plurality of local networks.

19. The computer-readable medium of claim 18 wherein the receiving instructions further includes instructions for:
receiving the request for the service, the standard identifier including at least one standard local name corresponding to an address for accessing the service through the at least one local network.

20. The computer-readable medium of claim 19 wherein the locating instructions further include instructions for:
translating the at least one standard local name to the address.

21. The computer-readable medium of claim 18 wherein the instructions further include instructions for:
allowing a server on the local network to send out a heartbeat, the heartbeat indicating a presence of the local network; and
connecting to the local network based on the heartbeat.

22. A system for providing access to a service through any of a plurality of local networks comprising:
means for receiving a request for the service from a computing device through at least one of the plurality of local networks, the request including a standard identifier identifying the service for each of the plurality of local networks and associated with a location of the service for each of the plurality of local networks;
means for locating the service for the at least one of the plurality of local networks based on the standard identifier; and
means for allowing the computing device to access the service through the at least one of the plurality of local networks.

23. The system of claim 22 wherein the receiving means further include a gateway.

24. The system of claim 22 wherein the receiving means further include a dynamic host configuration protocol server.

25. The system of claim 22 wherein the standard identifier includes at least one standard local name, the at least one standard local name corresponding to an address.

26. The system of claim 25 wherein the locating means further locates the service using the address.

27. The system of claim 25 wherein the locating means further translates the at least one standard local name to the address and accesses the service at the address.

28. The system of claim 25 wherein the locating means further includes a domain name service server.

29. The system of claim 25 wherein the locating means further include a session internet protocol server.

30. The system of claim 25 wherein the receiving means includes a dynamic host configuration protocol (DHCP) server and wherein the locating means include a domain name service (DNS) server, the request being transferred from the DHCP server to the DNS server.

31. A computing device for obtaining access to a service through any of a plurality of local networks, the device comprising:
a user interface for initiating a request for the information from the computing device, the request including a standard identifier identifying the service for each of the plurality of local networks and associated with a location of the service for each of the plurality of local networks;
a communication subsystem for sending the request to the at least one of the plurality of local networks and for accessing the service through the at least one of the plurality of local networks.

32. The device of claim 31 wherein the standard identifier includes at least one standard local name, the at least one standard local name corresponding to an address.

33. The device of claim 31 wherein the user interface further generates the request on the computing device using a single command.

34. The device of claim 33 wherein the user interface includes a button that initiates the request at a push of the button.

35. The device of claim 33 wherein the user interface includes a menu item.
